(19) United States
(12) Patent Application Publication
(10) Pub. No.: US 2013/0254657 A1
(43) Pub. Date: Sep. 26, 2013

(54) FONT ADJUSTING METHOD AND ELECTRONIC DEVICE USING SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: REN-WEN HUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/730,864

(22) Filed: Dec. 29, 2012

(30) Foreign Application Priority Data
Mar. 22, 2012 (CN) 201210077785.3

(51) Int. Cl. G06F 17/21

(52) U.S. Cl. CPC G06F 17/214
USPC 715/268

(57) ABSTRACT

A font adjusting method employed in an electronic device. The electronic device includes a display screen and a sensor. The method includes detecting a moving state of the electronic device by the sensor when the display screen is turned on; enlarging a font size of text displayed on the electronic device when the electronic device is in a moving state; and controlling the display screen of the electronic device to use the enlarged font size.

### TECHNICAL FIELD

Embodiments of the present disclosure relate to a font adjusting method and an electronic device using the same.

### DESCRIPTION OF RELATED ART

Electronic devices such as a mobile phone include a screen to display information thereon using a predetermined font size. However, when in motion, such as walking, some users may not clearly see the information displayed on the screen using the predetermined font size.

Thus, there is a desire to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram illustrating one embodiment of an electronic device including a font size adjusting system.

FIG. 2 is a flowchart of one embodiment showing a font adjusting method of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include compact discs (CDs), digital video discs (DVDs), BLU-RAY disks, Flash memory, and hard disk drives.

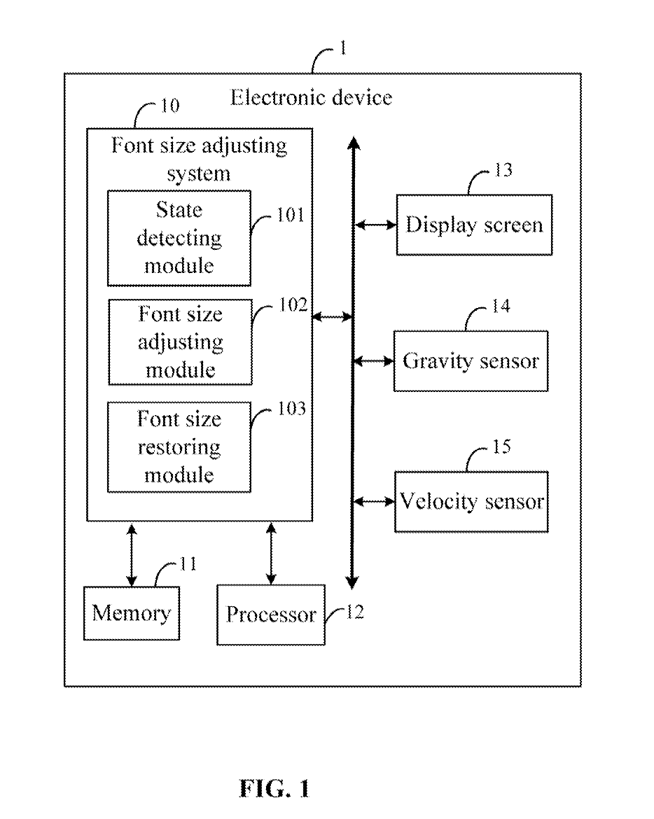

Referring to FIG. 1, a schematic block diagram illustrating one embodiment of an electronic device 1 including a font size adjusting system 10 is shown. The electronic device 1 further includes a memory 11, a processor 12, a display screen 13, a gravity sensor 14, and a velocity sensor 15. In this embodiment, the font size adjusting system 10 includes a state detecting module 101, a font size adjusting module 102, and a font size restoring module 103. The font size adjusting system 10 includes a plurality of programs in the form of one or more computerized instructions stored in the memory 11 and executed by the processor 12 to automatically enlarge the size of the font used in any text displayed on the display screen 13 when the electronic device 1 is detected to be in a moving state.

In the embodiment, the memory 11, the processor 12, the display screen 13, gravity sensor 14, and the velocity sensor 15 are connected with each other, directly or indirectly, for transferring data therebetween. In alternative embodiments, one of the gravity sensor 14 and the velocity sensor 15 may be omitted.

The state detecting module 101 controls the gravity sensor 14 and the velocity sensor 15 to detect a moving state of the electronic device 1 when the display screen 13 of the electronic device 1 turns on and is working normally. In one embodiment, the gravity sensor 14 detects an acceleration of the electronic device 1 when the display screen 13 of the electronic device 1 turns on and is working normally. The velocity sensor 15 may be a global positioning system receiver and detects a velocity of movement of the electronic device 1 when the display screen 13 of the electronic device 1 turns on and is working normally. When the detected acceleration or detected velocity is greater than predetermined values for a predetermined time, the processor 12 determines that the electronic device 1 is in a moving state. Otherwise, when the detected acceleration and detected velocity is less than or equal to the predetermined value for the predetermined time, the processor 12 determines that the electronic device 1 is stationary. In this embodiment, the first predetermined value of the acceleration and the second predetermined value of the velocity are pre-stored in the memory 11 by the processor 12.

The font size adjusting module 102 enlarges the font size of any text displayed on the display screen 13 to a predetermined font size when the electronic device 1 is determined to be in a moving state. In an alternative embodiment, the font size adjusting module 102 also gradually enlarges the font size of any text displayed on the display screen 13 commensurately with an increase of the detected velocity of the electronic device 1 or an increase of the detected acceleration of the electronic device 1 when the electronic device 1 is determined to be in a moving state.

In one embodiment, when the detected velocity is greater than a first predetermined value and less than a second predetermined value for the predetermined time, the font size adjusting module 102 enlarges the font size of text displayed on the display screen 13 to a first predetermined font size. When the detected velocity is greater than a second predetermined value for the predetermined time, the font size adjusting module 102 enlarges the font size of any text displayed on the display screen 13 to a second predetermined font size. The second predetermined font size is larger than the first predetermined font size. The second predetermined value is greater than the first predetermined value. In this embodiment, the first and the second predetermined font sizes and the first and the second predetermined values are pre-stored in the memory 11 by the processor 12.

In alternative embodiments, when the detected acceleration is greater than a first predetermined value and less than a second predetermined value for the predetermined time, the font size adjusting module 102 enlarges the font size of text displayed on the display screen 13 to a first predetermined font size. When the detected acceleration is greater than a second predetermined value for the predetermined time, the font size adjusting module 102 enlarges the font size of any text displayed on the display screen 13 to a second predetermined font size. The second predetermined font size is larger than the first predetermined font size. The second predetermined value is greater than the first predetermined value. In this embodiment, the first and the second predetermined font sizes and the first and the second values are pre-stored in the memory 11 by the processor 12.

The font size restoring module 103 resets, that is to say, reduces, the enlarged font size of the electronic device 1 to a default font size or an initial font size.

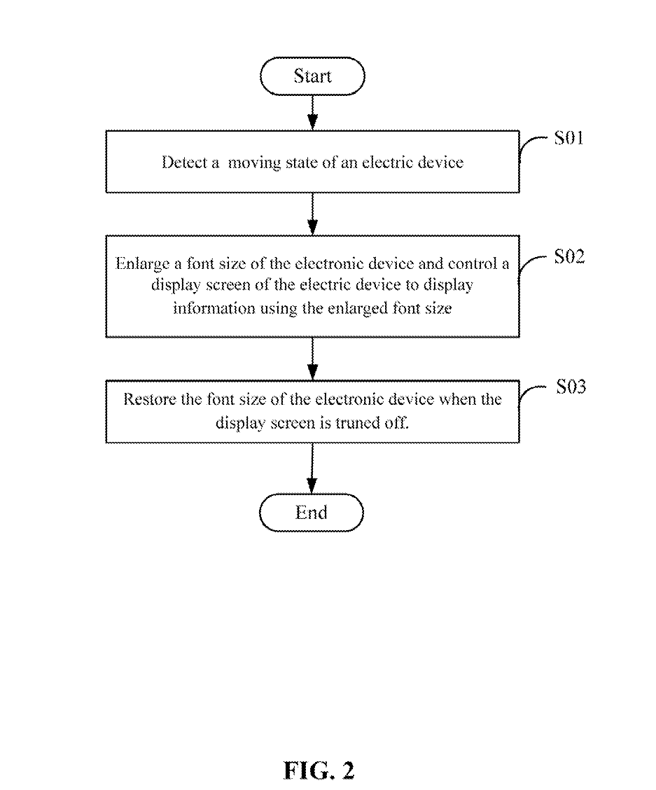

FIG. 2 is a flowchart of one embodiment showing a font adjusting method of the electronic device of FIG. 1. The method is carried out using the electronic device 1 to automatically adjust the font size of any text displayed on the display screen 13. Depending on the embodiment, additional steps may be added, others removed, and the ordering of the steps may be changed.

In step S01, the state detecting module 101 controls the sensors 14, 15 to detect if the electronic device 1 is in a moving state when the display screen 13 of the electronic device 1 is turned on and is working normally.

In step S02, the font size adjusting module 102 enlarges the font size of the electronic device 1 and controls the display screen 13 to display data in the enlarged font size when the electronic device 1 is detected to be in a moving state.

In step S03, the font size restoring module 103 restores and reduces the font size of the electronic device 1 to a default font size or an initial font size when the display screen 13 is turned off. In alternative embodiments, the font size restoring module 103 restores and reduces the font size of the electronic device 1 to a default font size or an initial font size when the electronic device 1 is detected to stop its movement for a period of time.

Even though numerous characteristics and advantages of certain inventive embodiments have been set out in the foregoing description, together with details of the structures and functions of the embodiments, the disclosure is illustrative only; and changes may be made in detail, especially in the matters of arrangement of parts within the principles of present invention to the full extent indicated by the broad general meaning of the terms in which the appended claims are expressed.

What is claimed is:

1. A font adjusting method employed in an electronic device, the electronic device comprising a display screen and a sensor, the method comprising:
detecting a moving state of the electronic device by the sensor when the display screen is turned on, and
enlarging a font size of the electronic device when the electronic device is in the moving state; and
controlling the display screen of the electronic device to display information using the enlarged font size.

2. The method of claim 1, further comprising restoring the font size of the electronic device to an initial font size when the display screen is turned off.

3. The method of claim 1, wherein the sensor comprising a gravity sensor for detecting an acceleration of the electronic device and a velocity sensor for detecting a velocity of the electronic device.

4. The method of claim 3, wherein the electronic device is defined to be in a moving state when the detected acceleration or detected velocity is greater than a predetermined value for a predetermined time.

5. The method of claim 4, further comprising gradually enlarging the font size of any text displayed on the display screen commensurately with an increase of the detected velocity of the electronic device or an increase of the detected acceleration of the electronic device.

6. The method of claim 5, further comprising enlarging the font size of any text displayed on the display screen to a first predetermined font size when the detected velocity is greater than a first predetermined value and less than a second predetermined value for the predetermined time, and enlarging the font size of any text displayed on the display screen to a second predetermined font size when the detected velocity is greater than a second predetermined value for the predetermined time.

7. The method of claim 6, wherein the second predetermined font size is larger than the first predetermined font size, the second predetermined value is greater than the first predetermined value.

8. The method of claim 5, further comprising enlarging the font size of any text displayed on the display screen to a first predetermined font size when the detected acceleration is greater than a first predetermined value and less than a second predetermined value for the predetermined time, and enlarging the font size of any text displayed on the display screen to a second predetermined font size when the detected acceleration is greater than a second predetermined value for the predetermined time.

9. An electronic device comprising:
a display screen configured for displaying information using an initial font size;
a sensor configured for detecting a moving state of the electronic device when the display screen is turned on; and
a font size adjusting system configured for enlarging a font size of the electronic device when the electronic device is in a moving state, and controlling the display screen of the electronic device to display information using the enlarged font size.

10. The method of claim 9, further comprising restoring the font size of the electronic device to an initial font size when the display screen is turned off.

11. The electronic device of claim 9, wherein the sensor comprising a gravity sensor for detecting an acceleration of the electronic device and a velocity sensor for detecting a velocity of the electronic device.

12. The electronic device of claim 11, wherein the electronic device is defined to be in a moving state when the detected acceleration or detected velocity is greater than a predetermined value for a predetermined time.

13. The electronic device of claim 12, wherein the font size adjusting system gradually enlarges the font size of any text displayed on the display screen commensurately with an increase of the detected velocity of the electronic device or an increase of the detected acceleration of the electronic device.

14. The electronic device of claim 13, wherein the font size adjusting system enlarges the font size of any text displayed on the display screen to a first predetermined font size when the detected velocity is greater than a first predetermined value and less than a second predetermined value for the predetermined time, and the font size adjusting system enlarges the font size of any text displayed on the display screen to a second predetermined font size when the detected velocity is greater than a second predetermined value for the predetermined time.

15. The electronic device of claim 14, wherein the second predetermined font size is larger than the first predetermined font size, the second predetermined value is greater than the first predetermined value.

16. The electronic device of claim 13, wherein the font size adjusting system enlarges the font size of any text displayed on the display screen to a first predetermined font size when the detected acceleration is greater than a first predetermined value and less than a second predetermined value for the predetermined time, and the font size adjusting system enlarges the font size of any text displayed on the display screen to a second predetermined font size when the detected acceleration is greater than a second predetermined value for the predetermined time.

17. The electronic device of claim 16, further comprising a memory for pre-storing the first predetermined font size, the second predetermined font size, the first predetermined value, and the second predetermined.
